(19) United States
(12) Patent Application Publication
(10) Pub. No.: US 2026/0242170 A1
(43) Pub. Date: Aug. 20, 2026

(54) SPREADING DEVICE, METHOD FOR SPREADING A FLAT MATERIAL WEB, SPREADING ROLLER, AND USE OF AN INDIVIDUAL SPREADING ELEMENT ON SUCH A SPREADING ROLLER

(71) Applicant: ROLF HESSENBRUCH, Remscheid (DE)

(72) Inventor: ROLF HESSENBRUCH, Remscheid (DE)

(21) Appl. No.: 19/123,612

(22) PCT Filed: Jan. 3, 2020
(86) PCT No.: PCT/DE2020/000001

§ 371 Date: Apr. 23, 2025

(30) Foreign Application Priority Data
Jan. 5, 2019 (DE) 10 2019 000 081.1

(51) Int. Cl. B65H 23/025

(52) U.S. Cl. CPC B65H 23/0251; B65H 2404/131; B65H 2701/17

(57) ABSTRACT

The invention relates to a spreading device for spreading a flat material web with a main spreading direction, comprising an elastically deformable support part for arranging on a rotational body and comprising a plurality of elastically deformable individual spreading elements for achieving a spreading effect oriented in the main spreading direction, wherein each individual spreading element has a contact surface region with a contact surface for interacting with the flat material web on the individual spreading element free end facing away from the support part, and the second end facing away from the free end is arranged on the support part. The spreading device is designed such that each individual spreading element can be tilted at least partly or completely in the direction of the free end under the effect of centrifugal forces.

The invention relates to a spreading device for spreading a flat material web with a main spreading direction, with an elastically deformable support part for arranging on a rotational body and with a plurality of elastically deformable individual spreading elements to achieve a spreading effect directed in the main spreading direction, in which the respective individual spreading element has a contact surface area at its free end facing away from the support part with a contact surface to Interact with the flat material web on the one hand and is arranged on the support part at its second end facing away from the free end on the other hand.

The invention relates to an expander roller for laterally spreading a flat material web in axial spreading directions with a peripheral surface by means of which the expander roller can be brought into operative contact with the flat material web, with a rotation axis around which the expander roller can rotate, and with spreading devices comprising a plurality of individual spreading elements which form the peripheral surface.

The invention also relates to an expander roller for laterally spreading a flat material web in axial spreading directions, with an enveloping peripheral surface by means of which the expander roller is brought into operative contact with a flat material web, with a rotation axis around which the expander roller can be rotated, and with a plurality of spreading element rings which form the peripheral surface and which are mounted from the center to the edge of the roller in the spreading direction, and the spreading element rings are equipped with individual spreading elements in such a way that each individual spreading element can move freely with and without load and with no contact with the neighboring elements.

The invention also relates to a method for spreading a flat material web with spreading devices, in particular an expander roller, in which a plurality of elastically deformable individual spreading elements of the spreading device are brought into operative contact with the flat material web, in which the spreading device rotates around a rotation axis during spreading of the flat material web, and in which the contact surface of the respective individual spreading element is deflected radially outward by centrifugal forces.

The invention also relates to the use of an individual spreading element on an expander roller.

It is conventional to flatten or spread a “running” product web or material web, such as a paper web, a fabric web, a film web, etc., which is moved along a conveyor line in the “running direction” or machine direction at a production speed, thereby laying it flat or spreading it out without creases by exerting spreading forces on the product web or material perpendicular to the running direction of the product or material web. For this purpose, devices referred to as expander rollers are known for such material webs, such as films made of thermoplastic material, paper, fleeces and other flat webs.

A conventional solution usable for thermoplastic films is the slightly curved rubber roller, referred to as a banana roller. However, these banana rollers move somewhat stiffly because the surrounding rubber jacket constantly deforms.

Another form of expander roller is the cord spreader, in which the film comes into contact with round cords that are stretched outward by a mechanism during contact, thereby generating a spreading force. However, these rollers are expensive, under some circumstances usually leave behind undesired markings on the film and require an additional drive.

Still other expander rollers consist of many individual components that are mechanically pulled outward during the contact time with the film and thereby create spreading forces and corresponding spreading effects on the film. However, these expander rollers are suitable only for very low speeds.

Other expander rollers consist of fiber bundles that are inclined outward and, when they come into contact with the product web, tilt slightly toward the edge of the roller, which creates the spreading,

Still other expander rollers (DE 10 2011 107 188 A1) have spreading devices made of rubber rings that are equipped with many individual spreading elements and also exert an outward movement when they come Into contact with the product web, thereby accomplishing the spreading process.

The aforementioned expander rollers are typically suitable for production speeds of 200 m/min. to a maximum of 300 m/min. At higher production speeds and the associated higher rotation speeds of the rollers, centrifugal forces acting on the spreading elements cause outward deformations of the spreading elements, which make clean spreading more difficult because the contact surfaces often no longer run essentially parallel to the product web or material web, but are then disadvantageously at a larger angle to the product web or material web, which can cause serious disruptions when spreading the product web or material web.

The invention is based on the general objective of further developing generic expander rollers and spreading devices provided therefor and of overcoming known disadvantages in this regard. In particular, the invention is based on the objective of providing spreading devices and expander rollers which are reliable and well suited even for higher production speeds.

These objectives are achieved according to a first aspect of the invention by a spreading device for spreading a flat material web with a main spreading direction, with an elastically deformable support part for arranging on a rotating body and with a plurality of elastically deformable individual spreading elements for achieving a spreading effect directed in the main spreading direction, in which the respective Individual spreading element on the one hand has a contact surface area with a contact surface for interacting with the flat material web and on the other hand is arranged at its second end facing away from the free end on the support part, whereby the spreading device is designed such that the respective individual spreading element can be tilted at least partially or entirely in the direction of the free end by means of centrifugal forces.

Since the individual spreading element can be tilted in the direction of the free end of the individual spreading element, relative to the support part of the individual spreading element, as soon as sufficiently high centrifugal forces act on this individual spreading element due to a sufficient rotational speed of the spreading device, a mere overall elastic deformation of the respective individual spreading element acting only in the direction of action of the centrifugal forces can be avoided or at least significantly reduced.

The rotation speed here depends on the RPM of the spreading device or an expander roller.

Rather, the individual spreading element in the present case is additionally deformed in such a way that it is also tilted or deformed in the direction of the free end, whereby elongation of the individual spreading element in the direction of action of the centrifugal forces is at least reduced.

In this respect, the invention provides a construction by means of which an increase in height of the individual spreading elements caused by centrifugal forces acting on the spreading device can be limited in the direction of action of the centrifugal forces.

This means within the sense of the invention that, with the aid of centrifugal forces, it is possible to displace contact surfaces of individual spreading elements of the spreading device at least partially not only exclusively in a radially outward direction, but additionally at least partially in one or more displacement directions deviating therefrom, namely in an axial direction and/or in a radially inward direction, wherein the said displacement directions are related to a rotation axis about which the individual spreading elements or the spreading device rotate.

Overall, the risk of undesirable diameter increases of an expander roller or spreading device rotating even at higher rotation speeds can be avoided or at least significantly reduced.

This in turn enables reliable production speeds (web speeds or conveying speeds) for flat material webs of more than 500 m/min or 700 m/min or preferentially up to 1000 m/min to be achieved.

Sufficiently high centrifugal forces act in particular on the spreading devices or on their individual spreading elements when they rotate at a corresponding rotational speed around their axis of rotation (axial direction) or around the axis of rotation (axial direction) of a rotating body on which they are arranged, of an expander roller.

In the present case, a contactless elongation limiter is thus created with regard to an individual spreading element, or a contactless diameter limiter with regard to an annular spreading device or with regard to an expander roller.

One possibility to limit the contact surface deformation or displacement in the current state of the art is simply to have the contact surfaces touch a stop that limits the diameter increase due to centrifugal force. The disadvantage, however, is that spreading on a flat material web can only take place when spreading elements can make a spreading movement. And this is only the case when the pressure of the flat material web on the spreading elements is greater than the centrifugal force on the spreading elements. Only then does spreading take place due to the spreading elements' ability to move freely. It is important that there be no restrictive conditions such as adequate web tension or overcoming of a stop, but that the spreading function work under all conditions.

In contrast to the prior art, the present invention allows the individual spreading elements to move freely even at high speeds, which means that even with light contact with the flat material web, the spreading elements can move in the spreading direction.

This means that the diameter limitation in the present invention occurs without contact due to the centrifugal forces acting on it.

In the case of an expander roller, which consists, for example, of rubber rings provided with a plurality of radial projections, referred to as individual spreading elements, a shape was found for the design of the individual spreading elements in which the effect of the centrifugal forces to produce a larger diameter of the rubber rings is eliminated or reduced.

In any case, the present spreading device enables an advantageous further development, In particular of spreading rollers, which in practice are often also referred to as expander rollers, for laterally spreading a flat material web in axial spreading directions or main spreading directions with a peripheral surface by means of which the spreading roller is brought into operative contact with the flat material web, and with a rotation axis around which the spreading roller rotates with a plurality of spreading devices, such as spreading element rings.

In the sense of the invention, the term “spreading device” describes any device that is at least partially, mostly preferentially, designed to be elastically deformable.

The spreading device has a support part (foot part) by means of which the spreading device can be attached to a rotational body of an expander roller. Furthermore, the support part carries the plurality of individual spreading elements of the spreading device. The support part can have a variety of shapes. The support part is preferentially designed as annular, in particular as a closed elastic ring part. Alternatively, the support part can also be designed in the shape of a band, for example as an elastic endless band part.

The spreading device with its support part and its individual spreading elements is predominantly, preferentially completely, made of an elastomer or a thermoplastic elastomer, such as an injection-molded part.

In addition to the support part, the spreading device also has several individual spreading elements that are arranged next to one another on the support part without contact. By means of the individual spreading elements, the spreading device comes into operative contact with a flat material web when the flat material web is guided over the spreading device or an expander roller equipped with it or when the spreading device or the expander roller rolls along the flat material web.

Furthermore, the spreading device has a main spreading direction in which the flat material web is spread when it comes into contact. In other words, this means that a spreading effect in the axial direction can be exerted on the flat material web by means of the spreading device or its individual spreading elements. This main spreading direction points in the direction of the longitudinal extension of the contact surface area of the individual spreading element, which is located radially further outward in relation to the support part. In other words, this means that the main spreading direction is guided in the direction in which the free end of the individual spreading element or the contact surface area points. For the sake of completeness, it should also be mentioned here that the main spreading direction points in the direction of the rotation axis (axial direction) around which the spreading device rotates when properly mounted with the expander roller.

In addition to the contact surface area, the individual spreading element is also characterized by a connecting area by means of which the contact surface area is elastically connected to the support part. As will be explained in more detail later, the connecting area is located at least largely radially further inward with respect to the support part than the contact surface area. More precisely, the connecting area is arranged between the contact surface area and the support part.

The connecting area also includes a bending area that is designed such that the individual spreading element or in particular the contact surface area can be tilted In the direction of the free end by means of centrifugal forces acting on the spreading device.

In particular, the connecting area and thus also the bending area includes a tilting axis of the individual spreading element. The tilting axis runs transversely to the main spreading direction. This is preferentially a fictitious tilting axis if the individual spreading element or the connecting area is deformed in some areas and a precise location of the tilting axis on the individual spreading element cannot be clearly determined.

As a result, the spreading device and in particular each of the Individual spreading elements comprises a tilting device which can be actuated automatically by rotation or centrifugal forces especially in order to reduce an elongation effect of the individual spreading element in the radially outward direction of action.

The object of the invention is also achieved according to a second aspect by a spreading device for spreading a flat material web with a main spreading direction, with an elastically deformable support part for arranging on a rotational body and with a plurality of elastically deformable individual spreading elements to achieve a spreading effect directed in the main spreading direction, by which the respective individual spreading element has a contact surface area at its free end facing away from the support part with a contact surface to interact with the flat material web on the one hand and is arranged on the support part at its second end facing away from the free end on the other hand, wherein the shape of the respective individual spreading element is selected such that a radial deflection of the contact surface in a radially outward direction can be reduced without contact by centrifugal forces acting on the respective individual spreading element.

In the course of the invention, it was recognized that, with a suitable choice of the shape of the individual spreading element, the self-rotation of the spreading device can be used to avoid a critical radial deflection, in particular of the contact surface of the individual spreading element, radially further outward; and this without contact.

Advantageously, it is already possible to limit or influence the radial deflection capacity of the individual spreading element simply by the structural design of the individual spreading element, in particular as a function of a rotation speed at which the spreading device rotates.

For example, this can be achieved by providing a corresponding tilting axis, which is preferentially provided at the connecting area of the individual spreading element.

Such a tilting axis can be formulated, for example, by corresponding material recesses and/or material accumulations or the like, which in turn are arranged in a bending area within the connecting area.

Preferentially, the contact surface area is located on a first side of the tilting axis and the remaining, larger area of the individual spreading element, in particular the connecting area, is located on another side of the tilting axis.

The term “contactless” in the sense of the invention describes that an individual spreading element is always freely movable relative to the same or other components or areas, in particular of the spreading device, and also remains freely movable for a deflection limitation or reduction, i.e. bypassing physical contact with the same or other components of the spreading device, related to normal operation of the spreading device.

According to a third aspect of the invention, the object is also achieved by a spreading device for spreading a flat material web with a main spreading direction, with an elastically deformable support part for arranging on a rotational body and with a plurality of elastically deformable individual spreading elements to achieve a spreading effect directed in the main spreading direction, by which the respective individual spreading element has a contact surface area at its free end facing away from the support part with a contact surface to interact with the fiat material web on the one hand and is arranged on the support part at its second end facing away from the free end on the other hand, wherein the deformation capacity of the respective individual spreading element is selected such that a radial deflection of the contact surface in a radially outward direction can be reduced by centrifugal forces acting on the respective individual spreading element.

Cumulatively or alternatively, by selecting the deformation capacity, in particular of the connecting area of the individual spreading element, it is possible to avoid a critical radial deflection, in particular of the contact surface of the individual spreading element, further radially outward.

For example, this can be achieved by having a less stiff contact surface area on a first side of the tilting axis and a remaining, stiffer area of the individual spreading element, in particular a stiffer connecting area, on another side of the tilting axis.

According to a fourth aspect of the invention, the object is also achieved by a spreading device for spreading a flat material web with a main spreading direction, with an elastically deformable support part for arranging on a rotating body and with a plurality of elastically deformable individual spreading elements for achieving a spreading effect directed in the main spreading direction, by which the respective Individual spreading element has, on the one hand, at its free end facing away from the support part, a contact surface area with a contact surface for interacting with the flat material web and, on the other hand, is arranged on the support part at its second end facing away from the free end, wherein the mass distribution of the respective individual spreading element is selected such that a radial deflection of the contact surface in a radially outward direction can be reduced by centrifugal forces acting on the respective individual spreading element.

Cumulatively or alternatively, by choosing the mass distribution, in particular of the connecting area of the individual spreading element, it is possible to avoid a critical radial deflection, in particular of the contact surface of the individual spreading element, further radially outward.

For example, this can be achieved by having a lighter contact surface area on a first side of the tilting axis and a remaining, heavier area of the individual spreading element, in particular a heavier connecting area, on another side of the tilting axis.

A preferential embodiment provides that the contact surface can be displaced radially further inward by centrifugal forces acting on the respective individual spreading element. It is particularly advantageous if the respective individual spreading element is designed in such a way that, at a correspondingly selected rotation speed, the contact surface or the contact surface area is displaced radially further inward and not further outward. This ensures that the circumference of the spreading device does not increase critically if the rotation speed critically approaches, reaches or exceeds a specified value.

The degree of displacement of the contact surface area of the individual spreading element in a radially inward direction can advantageously be determined as a function of the rotational speed.

It is expedient if the contact surface area of the respective individual spreading element can be deflected radially outward in the radial deflection direction by means of centrifugal forces and/or by means of rotation around a rotation axis of the expansion device, wherein the radial deflection direction of the contact surface area is different from a tilting direction of the individual spreading element. This ensures particularly reliably that, on the one hand, the contact surface is moved in the direction of the flat material web so that enough operative contact is achieved between the spreading device and the flat material web. On the other hand, however, excessive general widening of the spreading device can be avoided.

It is particularly expedient if the spreading device has a rotation axis around which the spreading device is rotatable, wherein the respective Individual spreading element can be tilted around a tilting axis at least partially or entirely in the axial direction of the rotation axis when rotating around the rotation axis. This allows tilting of the respective individual spreading element on the support part, depending on speed.

In this respect, an advantageous embodiment also provides that the respective individual spreading element can be tilted around a tilting axis at least in part or entirely in the main spreading direction by means of a rotation speed of the spreading device.

If the respective individual spreading element has an overall center of gravity that lies outside the contact surface area, It can be ensured that the contact surface moves radially further inward toward the support part as the rotation speed of the expansion device increases.

Preferentially, the overall center of gravity of the individual spreading element relative to the tilting axis lies on a side of the individual spreading element facing away from the contact surface.

As already explained above, it is advantageous if the respective individual spreading element has a connecting area that is arranged between the contact surface area and the support part. Preferentially, only the contact surface area and the connecting area as a whole form an individual spreading element.

If the respective individual spreading element is arranged on the support part by means of the connecting area in the axial direction of the spreading device so as to be movable, while the contact surface area is arranged on the connecting area so as to be movable in the radial direction, the contact surface area and the connecting area can be displaced in different directions of displacement at corresponding rotation speeds, in particular depending on the speed, as already explained elsewhere.

The construction of the spreading device can be kept very simple if the respective individual spreading element, in particular at its connecting area, is designed with a joint in order to enable a tilting movement in the sense of the invention.

In this context, it is advantageous if the connecting area comprises a bending area that has a tilting axis of the respective individual spreading element, around which the respective individual spreading element can be tilted relative to the support part. By means of the bending area or the tilting axis, such a joint can be easily integrated into the respective individual spreading element.

A further advantageous embodiment provides that the tilting axis spans a vertical plane, on the first vertical plane side of which facing the contact surface the contact surface area is arranged and on the second vertical plane side of which facing away from the contact surface the connecting area is arranged.

This allows tilting effects and deflection effects on the respective Individual spreading element to be coordinated particularly well.

In this context, the respective individual spreading element advantageously has at least two deformation areas, which are arranged on different vertical plane sides.

Preferentially, this vertical plane runs perpendicular to the support part with respect to an intersection line with the support part.

Cumulatively or alternatively, it is advantageous if the vertical plane is arranged perpendicular to the axis of rotation of the spreading device.

Overall, this allows the course of the vertical plane to be clearly determined on the spreading device, which also allows the positions of the contact surface area and the connecting area to be determined precisely.

The vertical plane runs through the respective individual spreading element.

For example, the contact surface area of the respective individual spreading element extends from the free end of the respective individual spreading element up to the vertical plane, wherein the contact surface area lies on the first vertical plane side of the vertical plane.

The connecting area, on the other hand, then extends on the second vertical plane side of the vertical plane from the support part of the respective individual spreading element up to the vertical plane.

Furthermore, it is advantageous if the respective individual spreading element has at least two deformation areas with different main deformation directions, wherein the at least two deformation areas are arranged at different radial heights. This can achieve different deformation effects.

It is similarly advantageous if the respective individual spreading element has at least two deformation areas with different deformation capacities, wherein the at least two deformation areas are arranged at different radial heights.

The spreading device can be further developed positively if the respective individual spreading element has at least two deformation areas with opposing and at least partially mutually canceling displacement effects, in particular with regard to the contact surface.

For the same reasons, it is advantageous if the respective individual spreading element has at least two deformation areas with opposing and at least partially mutually canceling deformation effects, in particular with regard to the contact surface.

The general tilting effects of the respective individual spreading element described here and the reduction effects of the deflection, in particular of the relevant contact surface, can be adjusted particularly reliably on the spreading device if the connecting area has a larger mass than the contact surface area. In particular, a lateral mass distribution can be selected depending on the speed.

In this respect, it is particularly useful if the connecting area has a higher weight than the contact surface area. In this way, the effects mentioned above can be achieved or manipulated. In this respect, a desired mass distribution can also be realized on the respective individual spreading element, in particular depending on a rotational speed to be achieved.

Cumulatively or alternatively, it is advantageous if the connecting area has a greater thickness than the contact surface area. In this way, it is possible to influence the deformation capacity of the respective individual spreading element, in particular as a function of a desired rotational speed.

Furthermore, it is advantageous if the connecting area has a greater curvature than the contact surface area. This makes it very easy to arrange the overall center of gravity of each individual spreading element on the side of the vertical plane facing away from the contact surface.

Overall, it is particularly advantageous if the respective Individual spreading element has a sickle-shaped deformation body. Advantageously, the contact surface area of a corresponding sickle-shaped deformation body is less curved than the connecting area of this sickle-shaped deformation body.

If necessary, the safety-shaped deformation body can also have further functional areas, such as a bending area.

It is understood that the contact surface area and the connecting area can be designed with different single centers of gravity.

A further particularly preferential embodiment provides that the connecting area has a single center of gravity that is arranged closer to a vertical plane spanned by the tilting axis than a single center of gravity of the contact surface area. This allows the respective individual spreading element to be of more compact construction.

In general, it can be stated that the respective individual spreading element inclines In the direction of its opening when sufficiently high centrifugal forces act on this individual spreading element, for example due to rotation of the spreading device or the expander roller.

In addition, the present spreading device can be advantageously further developed if the spreading device is made of an elastic material, in particular a thermoplastic material.

Preferentially, the spreading device consists of at least more than 50%, preferentially more than 80%, and particularly preferentially more than 90% elastic material, apart from mixed-in particles.

According to a fifth aspect of the invention, the object is also achieved by an expander roller for laterally spreading a flat material web in axial spreading directions with a peripheral surface by means of which the expander roller can be brought into operative contact with the flat material web, with a rotation axis around which the expander roller can be rotated, and with spreading devices comprising a plurality of individual spreading elements which form the peripheral surface, wherein the expander roller is characterized by spreading devices according to the features proposed here. This allows an expander roller to be operated particularly reliably and thus effectively

The object of the invention is also achieved according to a sixth aspect by an expander roller for laterally spreading a flat material web in axial spreading directions, with an enveloping peripheral surface, by means of which the expander roller is brought into operative contact with a flat material web, with a rotation axis around which the expander roller can be rotated, and is loosened with a plurality of spreading element rings which form the peripheral surface and which are mounted from the center to the edge of the roller in the spreading direction, and the spreading element rings are equipped with individual spreading elements in such a way that each individual spreading element can move freely with and without load without contact with the neighboring elements, whereby the position of the center of gravity of each individual spreading element is configured such that the effect of the centrifugal force at high speeds at least partially does not affect the diameter increase of the spreading roller and the contact surfaces remain parallel or at a small angle to the web under the influence of centrifugal force and perform spreading under all operating conditions, and the individual spreading elements remain free and without contact with any limiting means in their functional position even without contact with the material web.

In this way, critical radial deflection further radially outward, particularly of the contact surface of the individual spreading element, can be avoided or significantly reduced.

The object of the invention is also achieved according to a seventh aspect by an expander roller for laterally spreading a flat material web in axial spreading directions with an enveloping peripheral surface, by means of which the expander roller is brought into operative contact with a flat material web, with a rotation axis about which the expander roller can be rotated, and with a plurality of spreading element rings which form the peripheral surface and are mounted from the center to the edge of the roller in the spreading direction, and the spreading element rings are equipped with individual spreading elements in such a way that each Individual spreading element can move freely with and without load without contact with the neighboring elements, wherein the position of the center of gravity of the bridge part and the position of the center of gravity of the contact part relative to the pivot point are designed in such a way that the effect of the centrifugal forces is at least partially canceled out and thus no or only a slight increase in the diameter of the expander roller occurs.

This also makes it possible to avoid or significantly reduce a critical radial deflection, particularly of the contact surface of the individual spreading element, further radially outward.

A further advantageous embodiment provides that the mass volume of the connecting area is larger than the mass volume of the contact surface area and both parts are arranged on different sides relative to the pivot point, thereby at least partially canceling out the effect of the centrifugal forces. In this way, a critical radial deflection, particularly of the contact surface of the individual spreading element further radially outward, can be avoided even better or significantly reduced.

If the individual spreading elements are mounted in a single row on the support part and thus designed to form an expansion element ring, a simply constructed expansion device can be realized.

If the individual spreading elements are mounted in double rows on the support part and thus designed to form an expansion element ring, disadvantageous continuous circumferential gaps can be easily avoided by design.

If double-row designs are provided with additional equipment on the support part to facilitate assembly and to prevent rotation, which is designed as gearing or with guide elements in the form of guide lugs, the operational reliability can also be increased.

Advantageously, each individual spreading element is C-shaped and the shape of the C is designed such that the connecting area and the contact surface area are formed as a rounded arch without any noticeable step and the connecting area is tapered toward the support part.

Further advantageous characteristics are explained below: The individual spreading elements are each connected to the support part, which is mounted on a rotating body. A plurality of spreading devices designed as rings form an expander roller. Each individual spreading element consists of a bridge part in the form of the connecting area and a contact part in the form of a contact surface area. The contact part establishes the active contact with the product web, and the bridge part connects the support part with the contact part. The smallest cross-section of the individual spreading element is preferably provided in the transition area between the support part and the bridge part, which means that the main rotational, tilting or inclining movement of the individual spreading element takes place here, and thus the greatest flexibility of the individual spreading element is present in this transition area.

In the present case, the shape of an individual spreading element is preferentially designed such that the bridge part and the contact part describe a large common arc which transitions seamlessly from the contact part into the bridge part.

This ensures that, regardless of the load, the contact area always touches the product web slightly curved and without a sharp edge.

The point of application of centrifugal forces is normally the center of gravity of the individual spreading element.

The further the center of gravity is located from the pivot point or tilting axis, the greater the torque due to centrifugal forces and the greater the increase in diameter outward.

One aim of the present invention must therefore be to place the center of gravity of the individual spreading element as close as possible to the pivot point or the tilting axis in order to reduce the torque caused by the centrifugal forces and at least partially neutralize the effect of the centrifugal forces.

For this purpose, it is necessary to move the distribution of the mass of each individual spreading element close to the pivot point or the tilting axis so that the individual centrifugal forces acting on the mass at least partially cancel each other out.

This means that the distribution of mass in particular determines the behavior of each individual spreading element.

This makes it possible to at least limit the effect of the centrifugal forces without external influences through stops or other limitations and, in particular, to create a contactless diameter limitation in which the freedom of movement of each individual spreading element is fully preserved and thus also the unrestricted functionality of the spreading even with the slightest contact by the product web, whereby the parallelism of the contact surface to the product web only changes within the permissible range without changing the function of the spreading.

The arrangement of the individual spreading elements on the support part can be in either a single row or a double row.

In the double-row solution, every second individual spreading element is axially offset by a maximum of half the contact surface length. This makes it possible, when the spreading devices or the spreading rings are mounted on the rotational body, to arrange them in such a way that the individual spreading elements interlock and are thus mounted “on a gap” without a continuous ring gap.

Since these spreading devices or spreading rings are preferentially manufactured using the injection molding process, they can be manufactured very precisely and allow designs that are not possible using the extrusion process, for example.

For example, the bridge part can be designed so that it is tapered toward the support part, thus allowing the spreading behavior to be influenced by the shape.

In the sense of the invention, the term “spreading element ring” essentially comprises a support part with individual spreading elements arranged thereon, which project radially further outward beyond the outer surface of the support part.

The support part can be realized as an open ring or, preferentially, as a closed ring.

The Injection molding process also allows production of finite profile lengths in the form of open rings, which are manufactured according to the shapes of the individual spreading elements discussed here.

By means of suitable designs of the profile ends, these individual profile lengths can be assembled into continuous profiles in a form-fitting manner using suitable processes such as gluing or similar, whereby the properties and detailed designs in terms of their function correspond to those of the individual spreading elements described here.

With these continuous profiles, roller supports of any diameter can be produced by winding them into expander rollers. The wrapping technique is done from the center of the roller outward with the corresponding spreading alignment to the end of the roll.

It is important for all solutions that the distance between each individual spreading element and the adjacent spreading element is large enough to allow enough freedom of movement to perform the spreading function without affecting a neighboring element. Because each individual spreading element performs its spreading function individually. This is, among other things, an essential factor for the excellent spreading function.

According to a seventh aspect, the object of the invention is also achieved by a method for spreading a flat material web with spreading devices, in particular an expander roller, in which a plurality of elastically deformable individual spreading elements of the spreading device are brought into operative contact with the flat material web, and in which the spreading device rotates around a rotation axis during the spreading of the flat material web, and in which the contact surface of the respective individual spreading element is deflected radially outward by centrifugal forces, wherein a radial deflection of the contact surface in a radially outward direction is reduced by centrifugal forces acting on the respective individual spreading element, while the individual spreading element is tilted around a tilting axis by the centrifugal forces.

In this way, critical radial deflection further radially outward, particularly of the contact surface of the individual spreading element, can be avoided or significantly reduced.

According to an eighth aspect of the invention, the present object is also achieved by the use of an individual spreading element on an expander roller for reducing a radially outward deflection of a contact surface arranged on the individual spreading element as a function of centrifugal forces acting on the individual spreading element.

In this way, critical radial deflection further radially outward, particularly of the contact surface of the individual spreading element, can be avoided or significantly reduced.

It should also be noted that, in the context of the patent application at hand, indefinite articles and indefinite numerical expressions such as “one . . . ”, “two . . . ”, etc., should generally be understood as at least expressions, i.e. as “at least one . . . ”, “at least two . . . ”, etc., unless it is clear from the context or the specific text of a particular passage that only “exactly one . . . ”, “exactly two . . . ”, etc. are meant there.

At this point, it should be mentioned that, in the context of the present patent application, the expression “in particular” is always to be understood as meaning that this expression Introduces an optional, preferential feature. The expression is not to be understood as “in fact” and not as “namely”.

At this point, it should also be claimed that the method described can also be supplemented by further technical features described here, In particular by features of the spreading device or the expander roller, in order to advantageously further develop the method or represent or formulate method specifications even more precisely.

It is understood that features of the solutions described above or in the claims can also be combined, if necessary, to implement the advantages and effects that can be achieved in a cumulative manner.

Further features, effects and advantages of the present invention are explained with reference to the attached drawing and the following description, in which an example of an expander roller and spreading devices therefor with individual spreading elements are shown and described.

Components that are at least essentially identical in terms of their function in the individual figures can be identified by the same reference numerals, whereby the components do not have to be numbered and explained in all figures.

### IN THE DRAWING

FIG. 1 schematically shows a sectional view of an expander roller with annular spreading devices each comprising a plurality of individual spreading elements;

FIG. 2 schematically shows a sectional view of a single annular spreading device from FIG. 1;

FIG. 3 schematically shows a sectional view of an individual spreading element of the annular spreading device shown in FIG. 2;

FIG. 4 schematically shows another sectional view of the individual spreading element rotated by 90° from FIG. 3;

FIG. 5 schematically shows a detailed view of another individual spreading element of the annular spreading device shown in FIG. 2 in an unloaded state or resting state and in a working state loaded by a flat material web;

FIG. 6 schematically shows a detailed view of an individual spreading element with visually highlighted contact surface area and connecting area with respective individual focal single centers of gravity thereon;

FIG. 7 schematically shows a detailed view of the contact surface area from FIG. 6 in a resting state (dashed representation) and in a rotation state subjected to centrifugal forces;

FIG. 8 schematically shows a detailed view of the connecting area from FIG. 6 in a resting state (dashed representation) and in a rotation state subjected to centrifugal forces;

FIG. 9 schematically shows a further detailed view of the contact surface area and the connecting area from FIGS. 6 to 8 with another representation of centrifugal forces;

FIG. 10 schematically shows a sectional view of an alternative expander roller with alternative annular spreading devices comprising individual spreading elements arranged in double rows;

FIG. 11 schematically shows a sectional view of a single alternative annular spreading device from FIG. 10;

FIG. 12 schematically shows a sectional view of a single further alternative annular spreading device with an additional multi-tooth profile;

FIG. 13 schematically shows a sectional view of another single annular spreading device with additional guide lugs; and

FIG. 14 schematically shows a top view of an alternative expander roller with double-row annular spreading devices.

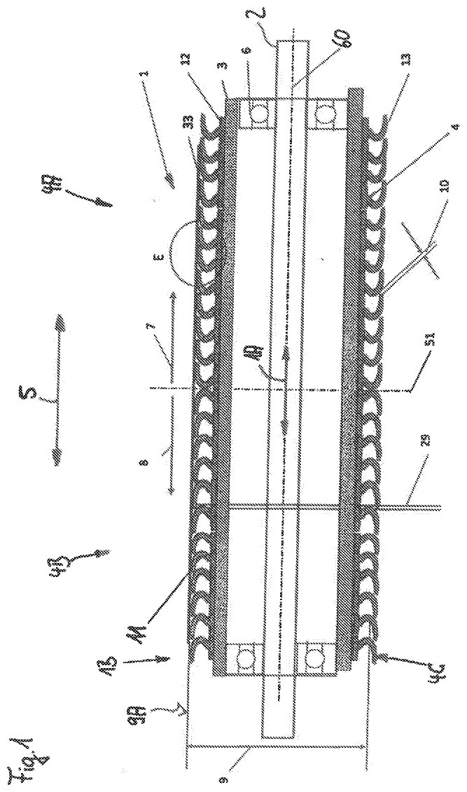

In the first embodiment shown in FIG. 1, an expander roller 1 according to the present invention is shown. The expander roller 1 essentially consists of a shaft 2, on which a tubular rotary body 3 is rotatably mounted on rolling bearings 6.

A number of spreading devices 4 are mounted on this rotational body 3 in such a way that they spread axially outward from the center or center line 51 of the expander roller 1 in the axial direction 1A of the expander roller 1 or the spreading devices 4 (only as an example); in the case of the spreading devices 4A arranged to the right of the center line 51, which spread to the right 7 in the main spreading direction 5 according to their arrangement, and the spreading devices 4B arranged to the left of the center line 51, which in contrast spread to the left 8 in the main spreading direction 5.

In this first embodiment, the spreading devices 4 are designed as spreading element rings 4C (numbered only as an example).

The spreading devices 4 are made of an elastic rubber-like material by injection molding.

The spreading devices 4 each have, on the one hand, an annular, elastically deformable support part 12 or a support ring, by means of which they can be arranged on the rotating body 3 of the expander roller 1. On the other hand, the spreading devices 4 each comprise a plurality of elastically deformable individual spreading elements 11 for achieving a spreading effect directed in the main spreading direction 5 on a flat material web 33 or product web in operative contact with the individual spreading elements 11.

The external diameter 9 realized by the spreading device 4 is at the same time the enveloping 9A of the expander roller 1, wherein this external diameter 9 or this enveloping 9A is formed by contact surfaces 13 of the individual spreading elements 11.

The annular support part 12 or the support ring lies flush on the rotational body 3 and, like the spreading element rings 4C, consists of elastic rubber-like material.

The effect of the spreading devices 4 is that the web pressure of the flat material web 33 running over it causes a slight deformation toward the respective roller edge 1B, which is small but is repeated per revolution of the expander roller 1 or the spreading devices 4 in accordance with the number of Individual spreading elements 11, so that the sum of the deformation leads to a clear but gentle spreading of the flat material web 33.

Since a corresponding gap 10 of 1 mm to 2 mm must be provided for the respective deformation, a circumferential ring gap 29 is formed when the spreading devices 4 are mounted on the rotational body 3. This ring gap 29 occurs in single-row spreading devices 4, but in double-row spreading devices 4 it does not occur in this continuous circumferential form.

These expander rollers 1 are usually not driven, and they spread equally well in both directions of rotation, regardless of the direction in which the expander roller 1 or the spreading devices 4 rotate about their axis of rotation 60.

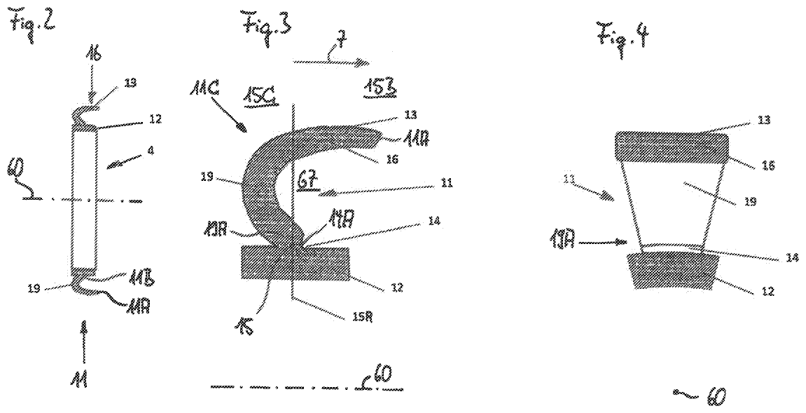

According to the representation in FIG. 2, the structure of a single-row spreading device 4 is shown as an example, which essentially consists of the support part 12 and the plurality of individual spreading elements 11.

The respective individual spreading element 11, in turn, has, on the one hand, at its free end 11A facing away from the support part 12, a contact surface area 16 (or a contact part) with the contact surface 13 for interacting with the flat material web 33. On the other hand, the individual spreading element 11 is arranged on the support part 12 at its second end 11B facing away from the free end 11A.

The contact surface area 16 is connected to the support part 12 by means of a 19 (either bridge part or connecting web). The special shape of the connecting area 19 or connecting bridge determines, among other things, the spreading properties and the behavior at high speeds.

Each individual spreading element 11 has essentially the shape of the capital letter C, as shown in particular in the representation in FIG. 3.

Put more precisely, each individual spreading element 11 has a sickle-shaped deformation body 11C.

FIG. 3 shows schematically an enlarged cross-section, in particular through the spreading device 4. As already explained above, the spreading device 4 essentially consists of the support part 12, which is ring-shaped. The support part 12 establishes the connection to the rotational body 3 (see FIG. 1) and is simultaneously the anchor point for all individual spreading elements 11 of the spreading device 4.

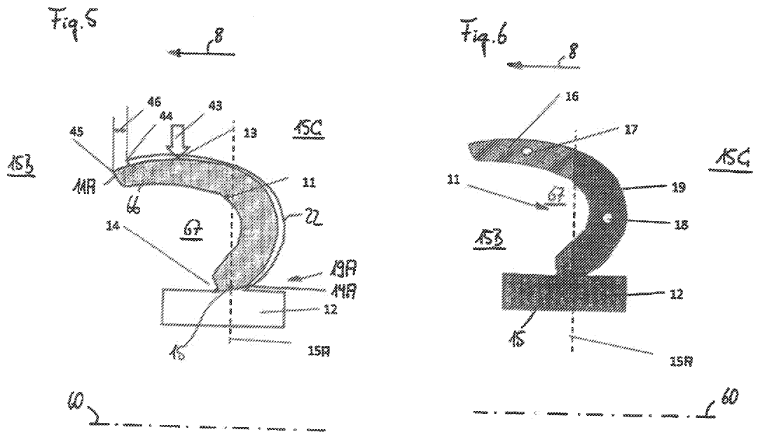

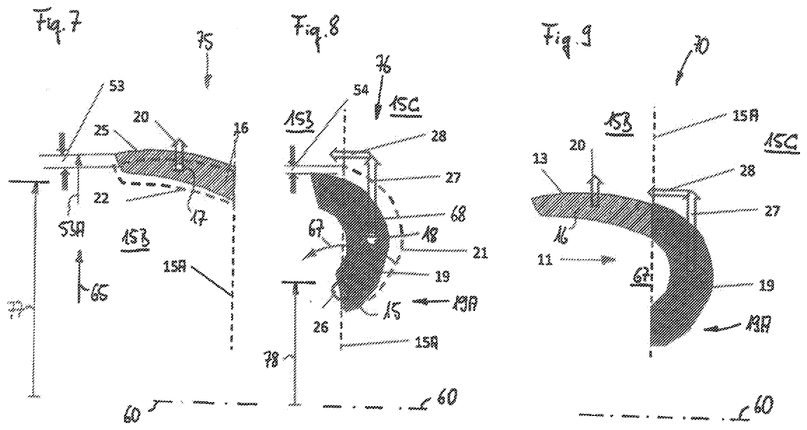

In this embodiment, the connecting area 19 is tapered toward the support part 12, as can be clearly seen from the representation in FIG. 4,

This tapering also determines the rigidity of the individual spreading element 11 and is specified by the injection mold.

In order to precisely determine the smallest cross-section and thus to determine the flexibility of the individual spreading element 11, a ring notch 14 is additionally provided, which marks a bending line (not separately numbered) at the transition area 14A between the connecting area 19 and the support part 12.

The individual spreading element 11 additionally has a bending area 19A at the connecting area 19.

In this bending area 19A, a tilting axis 15 (shown only schematically here) or rotation axis is formed, around which the individual spreading element 11 can be tilted in an idealized manner, at least in part or entirely, in the direction of the free end 11A by means of centrifugal forces (cf. in particular FIGS. 7 to 9).

The tilting axis 15 together with the rotation axis 60 of the spreading device 4 forms a vertical plane 15A which is arranged vertically to the rotation axis 60. By means of the vertical plane 15A, a first vertical plane side 15B and a second vertical plane side 15C are defined on the spreading device 4.

The special feature of the design in this embodiment is that the connecting area 19 (or the bridge part) and the contact surface area 16 (or the contact part) have a continuous arc shape without critical edges or other discontinuity. This ensures that regardless of the inclination of the contact surface 13—that is, regardless of the load from the flat material web 33—a large, smooth contact surface 13 is always available for the flat material web 33. In this way, markings on the flat material web 33 caused by sharp edges of the individual spreading element 11 can be safely avoided.

According to the representation in FIG. 5, an individual spreading element 11 is also shown, which in this case spreads to the left in the left spreading direction 8. Due to the force 43 exerted by the flat material web 33 or the product web, the individual spreading element 11 is pressed slightly radially downward from its starting position 22 (resting state) and thereby receives a new stress point 66, which can be recognized in particular by the change in position with respect to the correspondingly shown tips 44 and 45 of the free end 11A of the individual spreading element 11. The changed position creates the spreading gap 46. This spreading gap 46 represents the actual achievable spreading of the individual spreading element 11. In reality, it is only a few tenths of a millimeter in size, but the sum of all small movements results in a strong but gentle spreading of the flat material web 33, since this process is repeated 30 to 40 times per roller revolution alone, depending on the number of individual spreading elements 11.

FIG. 6 shows the same individual spreading element 11 from FIG. 5. In relation to the tilting axis 15 or the vertical plane 15A, the connecting area 19 with its single center of gravity 18 is shown on the second vertical plane side 15C (right side), and the contact surface area 16 with its single center of gravity 17 is shown on the first vertical plane side 15B (left side).

The movable or deformable parts are therefore the connecting area 19 and the contact surface area 16, the support part 12 serves as a fixed point for each individual spreading element 11.

The dashed vertical line represents the vertical plane 15A in which the tilting axis 15 or the bending line lies, and the vertical plane 15A divides the individual spreading element 11 into a left and right side and, through its position, determines the influence of centrifugal forces (cf. FIGS. 7 to 9) on the deformation of the individual components contact surface area 16 and connecting area 19. This tilting axis 15 acts as a pivot point around which the individual spreading element 11 rotates or tilts, namely in the direction of the opening 67 of the individual spreading element 11.

The representation of the contact surface area 16 shows, according to the representation in FIG. 7, an increase in diameter 53 or a radial deflection 53A due to centrifugal force effects. Due to centrifugal forces 20, the contact surface area 16 changes from its starting position 22 (dashed line) in the radial deflection direction 65 into the deflection position 25. These centrifugal forces 20 arise and act due to a corresponding rotation of the spreading device 4, whereby the contact surface area 16 moves radially outward in the action direction of the centrifugal forces 20 and produces an increase in diameter 53 on the spreading device 4 or the expander roller 1.

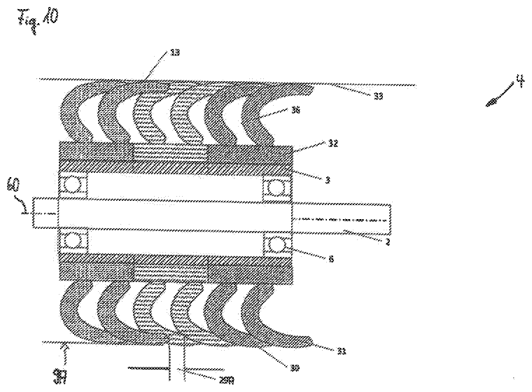

Centrifugal forces 27 act radially outward on the connecting area 19 of the rotating spreading device 4 shown in FIG. 8 and generate a centrifugal force component 28 in the axial direction 1A around the tilting axis 15 or the fictitious pivot point 26 (cf. FIG. 1), which generates a tilting movement in the tilting direction 67 or rotation in particular of the connecting area 19 around the fictitious pivot point 26 and thus moves the connecting area 19 from the original position 21 into the new tilted position 68. This movement is associated with a diameter reduction 54 (see FIG. 8), i.e. the diameter increase 53 (FIG. 7) and the diameter reduction 54 (FIG. 8) cancel each other out at least partially and keep the contact surface 13 in a favorable operating position 70 (see FIG. 9).

These centrifugal forces 20 and 27 acting on the individual spreading element 11 (see in particular FIG. 9) and the resulting centrifugal force component 28, which counteracts the centrifugal force movement radially outward, prevent excessive movement of each individual spreading element 11, in particular of the contact surface area 16, radially outward and thus hold each individual spreading element 11 in an optimal operating position 70 relative to the flat material web 33 in order to spread the flat material web 33 or the material web even at low material web pressure in that each individual spreading element 11 can react even to low pressure and performs a movement or spreading in a main spreading direction 5.

It should be emphasized here that each individual spreading element 11 is always fully movable and every force always triggers a spreading movement, whereby each individual spreading element 11 works completely independently of every other individual spreading element 11 and no other individual spreading element 11 is influenced as a result. This is one of the main advantages over many other systems for spreading flat material webs 33.

It should also be mentioned that the individual spreading element 11 in this embodiment has two deformation areas 75 and 76 with different main deformation directions 65 and 67, respectively, wherein the at least two deformation areas 75 and 76 are arranged at different radial heights 77 and 78, respectively (see FIGS. 7 and 8).

In the single-row designs, a circumferential ring gap 29 can arise between the individual spreading rings 11 in the operating state (see FIG. 1), In the case of very thin flat material webs 33 or product webs less than 10 to 15 microns or micrometers, for example, this can lead to the product web edge of the flat material web 33 bending into such a ring gap 29 and causing a side fold on the flat material web 33.

To avoid areas that have no or only limited spreading behavior, spreading devices 4 with double rows 36 can be used. The individual spreading elements 11 are mounted in two rows on the wider ring-shaped support part 32 (see FIG. 10). The individual spreading elements 30 and 31 are arranged such that adjacent individual spreading elements 30 and 31 are axially offset from one another by a maximum of half the contact surface length.

The necessary freedom of movement of the individual spreading elements 30 and 31 is achieved by the gap 29A, whereby the offset of the contact surfaces 13 or the contact surface areas 16 results in a very uniform enveloping 9A on which the flat material web 33 or the product web runs very gently in active contact with the contact surfaces 13. This avoids a continuous ring gap 29 (see FIG. 1) and the associated disadvantages of buckling of the web ends.

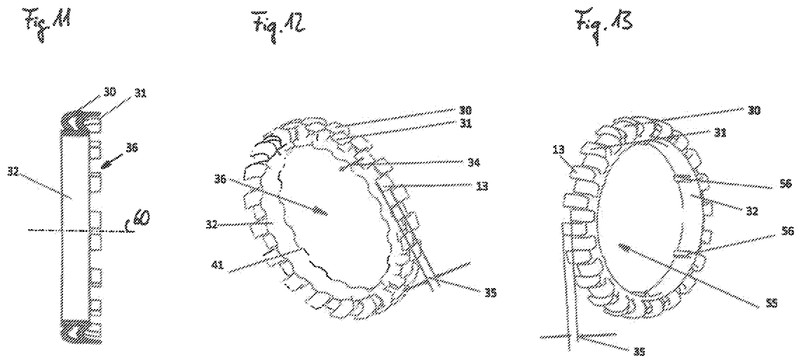

According to the representation in FIG. 11, a section through such a double-row spreading device 36 is shown with the individual spreading elements 30 and 31 spreading in the same axial direction 1A, which are applied to the support part 32.

FIG. 12 shows such a spreading device 4 equipped with double rows 36 with the individual spreading elements 30 and 31, which spread in the spreading direction 34. The axial offset 35 of the contact surfaces 13 or the contact surface areas 16 corresponds to a maximum of half the length of the contact surface 13 or the contact surface area 16.

Since the annular spreading devices 4 have to be mounted exactly in space with respect to an alternative expander roller 40, as shown in FIG. 14, the annular spreading devices 4 can be equipped with gearing 41 on the support part 32 for precise mounting and positional fixing. In this way, the movement gap 39, which is necessary for the freedom of movement of each individual spreading element 30 and 31, can be precisely maintained.

A further advantage of this solution can also be seen in the fact that in the roller center 42 (see FIG. 14) the spreading element rings 37 and 38 spreading to the right and left engage with each other in such a way that a continuous circumferential gap 29 (see FIG. 1) is avoided.

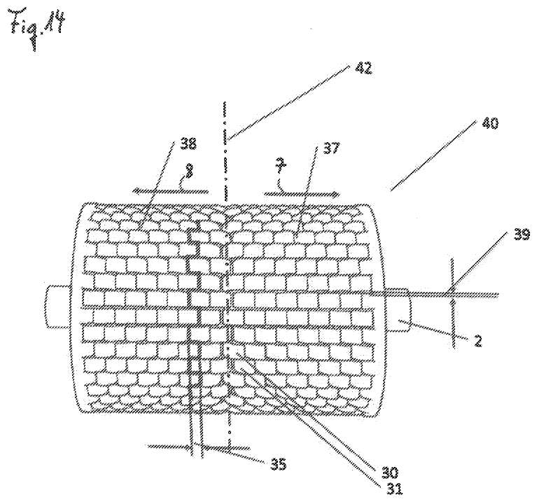

Instead of the gearing 41 (see FIG. 12), guide lugs 56 according to FIG. 13 can also be provided. For this purpose, corresponding guide grooves (not shown) must be embedded in a suitably designed rotating body 3. The guide lugs 56 are attached inside on the support part 32 The advantage is that precise alignment is always achieved during assembly. Since the assembly of a rotational body 3 to form an expander roller 1 or 40 is to be done with only one type of spreading device 4 or spreading element rings 37 and 38, care must be taken when designing the corresponding spreading element rings 55 to ensure that the number of guide lugs 56 and the pitch of the individual spreading elements 30 and 31 are precisely coordinated with one another. Therefore, this spreading element ring 55 consists of 42 individual spreading elements (21 of type 31 and 21 of type 31) and six guide lugs 56. The guide lugs 56 act both as assembly aids and as rotation protection for the spreading element rings 55.

The designs described here essentially concern expander rollers 1 or 40 for higher speeds. This includes speed ranges between 300 m/min and 1000 m/min web speeds.

At this point, it should be explicitly pointed out that features of the solutions described above or in the claims and/or figures can also be combined if necessary to implement or achieve the explained features, effects and advantages in a cumulative manner.

It is understood that the embodiments explained above are merely first embodiments of the invention. In this respect, the embodiment of the invention is not limited to these embodiments.

All features disclosed in the application documents are claimed as essential to the invention, provided that they are new compared to the prior art, either individually or in combination with one another.

### LIST OF REFERENCE SYMBOLS USED

1 Expander roller
1A Axial direction
1B Roller edges
2 Shaft
3 Rotational body
4 Spreading devices
4A Right spreading devices
4B Left spreading devices
4C Spreading element rings
5 Main spreading direction
6 Bearing
7 Right spreading direction
8 Left spreading direction
9 External diameter
9A Enveloping or peripheral surface
10 Gap between individual spreading elements
11 Individual spreading elements
11A Free end
11B Second end
11C Sickle-shaped deformation body
12 Ring-shaped support part or support ring
13 Contact surfaces
14 Ring notch
14A Transition area
15 Tilting axis
15A Vertical plane
15B First vertical plane side
15C Second vertical plane side
16 Contact surface area or contact part
17 Single center of gravity of the contact surface area
18 Single center of gravity of the connecting area
19 Connecting area or bridge part or connecting bridge
19A Bending area
20 Centrifugal forces, especially operating on the contact surface area
21 Original position
22 Starting position
25 Deflection position
26 Fictitious pivot point
27 Centrifugal forces, especially on the connecting area
28 Centrifugal force components
29 Ring gap
29A Gap
30 Individual spreading elements (first row)
31 Individual spreading elements (second row)
32 Wider ring-shaped support part or support ring
33 Flat material web or product web
34 Spreading direction
35 Axial offset
36 Double rows
37 Other spreading element rings
38 Other spreading element rings
39 Movement gap
40 Alternative expander roller
41 Gearing
42 Roller center
43 Force
44 Representation of the tip of the unstressed individual spreading element
45 Representation of the tip of the stressed individual spreading element
46 Spreading gap
51 Center or center line
53 Diameter increase
53A Radial deflection
54 Diameter reduction
55 Spreading element rings
56 Guide lugs
60 Rotation axis
65 Radial direction directed radially outward
66 Stress point
67 Tilting direction
68 Tilted position
70 Favorable operating position
75 First deformation area
76 Further deformation area
77 Upper radial height of the first deformation area on the contact surface area
78 Lower radial height of the other deformation area on the connecting area

1. A spreading device (4, 4A, 4B, 4C) for spreading a flat material web (33) with a main spreading direction (5, 7, 8), with an elastically deformable support part (12) for arranging on a rotational body (3) and with a number of elastically deformable individual spreading elements (11; 30, 31) to achieve a spreading effect directed in the main spreading direction (5, 7, 8), in which the respective individual spreading element (11; 30, 31) has a contact surface area (16) at its free end (11A) facing away from the carrier part (12) with a contact surface (13) to interact with the flat material web (33) on the one hand and is arranged on the carrier part (12) at its second end (11B) facing away from the free end (11A) on the other hand, characterized In that the spreading device (4, 4A, 4B, 4C) is designed such that the respective individual spreading element (11; 30, 31) can be tilted at least partially or entirely in the direction of the free end by means of centrifugal force (27).

2. A spreading device (4, 4A, 4B, 4C) for spreading a flat material web (33) with a main spreading direction (5, 7, 8), with an elastically deformable carrier part (12) for arranging on a rotational body (3) and with a plurality of elastically deformable individual spreading elements (11; 30, 31) for achieving a spreading effect directed in the main spreading direction (5, 7, 8), in which the respective individual spreading element (11) on the one hand has, at its free end (11A) facing away from the carrier part (12), a contact surface area (16) with a contact surface (13) for interacting with the flat material web (33) and on the other hand is arranged on the carrier part (12) at its second end (11B) facing away from the free end (11A), according to claim 1, characterized in that the shape, and/or the deformability, and/or the mass distribution of the respective individual expansion element (11) is selected such that a radial deflection (53A) of the contact surface (13) in the radially outward direction (65) can be reduced, in particular without contact, by centrifugal forces (27) acting on the respective individual expansion element (11).

3. A spreading device (4, 4A, 4B, 4C) according to claim 1, characterized in that the contact surface (13) can be displaced radially further inward by centrifugal forces (27) acting on the respective individual spreading element (11).

4. A spreading device (4, 4A, 4B, 4C) according to claim 1, characterized in that the contact surface area (16) of the respective individual spreading element (11) can be deflected radially outward in a radial deflection direction (65) by means of centrifugal force action (20) and/or by means of rotation around a rotation axis (60) of the spreading device (4, 4A, 4B, 4C), wherein the radial deflection direction (65) of the contact surface area (16) is different from a tilting direction (67) of the individual spreading element (11).

5. A spreading device (4, 4A, 4B, 4C) according to claim 1, characterized in that the spreading device (4, 4A, 4B, 4C) has a rotation axis (60) around which the spreading device (4, 4A, 4B, 4C) is rotatable, wherein the respective individual spreading element (11) is tiltable about a tilting axis (15) at least partially or entirely in the axial direction (1A) of the rotation axis (60) when rotating about the rotation axis (60).

6. A spreading device (4, 4A, 4B, 4C) according to claim 1, characterized in that the respective individual spreading element (11) can be tilted at least partially or entirely in the main spreading direction (5) around a tilting axis (15) by means of a rotational speed of the spreading device (4, 4A, 4B, 4C).

7. A spreading device (4, 4A, 4B, 4C) according to claim 1, characterized in that the respective individual spreading element (11) has an overall center of gravity that lies outside the contact surface area (16).

8. A spreading device (4, 4A, 4B, 4C) according to claim 1, characterized in that the respective individual spreading element (11) has a connecting area (19) that is arranged between the contact surface area (16) and the support part (12), whereby in particular the respective individual spreading element (11) is arranged on the support part (12) so as to be movable in the axial direction (1A) of the spreading device (4, 4A, 4B, 4C) by means of the connecting area (19), while the contact surface area (16) is arranged on the connecting area (19) so as to be movable in the radial direction (65).

9. A spreading device (4, 4A, 4B, 4C) according to claim 8, characterized in that the connecting area (19) comprises a bending area (19A) that has a tilting axis (15) of the respective individual spreading element (11), around which the respective individual spreading element (11) can be tilted relative to the support part (12).

10. A spreading device (4, 4A, 4B, 4C) according to claim 9, characterized in that the tilting axis (15) spans a vertical plane (15A), on whose first vertical plane side (15B) facing the contact surface (13) the contact surface area (16) is arranged and on whose second vertical plane side (15) facing away from the contact surface (13) the connecting area (19) is arranged.

11. A spreading device (4, 4A, 4B, 4C) according to claim 1, characterized in that the respective individual spreading element (11) has at least two deformation areas (75, 76) with different main deformation directions (65, 67), wherein the at least two deformation areas (75, 76) are arranged at different radial heights (77, 78).

12. A spreading device (4, 4A, 4B, 4C) according to claim 1, characterized in that the respective individual spreading element (11) has at least two deformation areas (75, 76) with different deformation capacities, wherein the at least two deformation areas (75, 76) are arranged at different radial heights (77, 78).

13. A spreading device (4, 4A, 4B, 4C) according to claim 1, characterized in that the respective individual spreading element (11) has at least two deformation areas (75, 76) with opposing and at least partially mutually canceling displacement effects, in particular with regard to the contact surface (13).

14. A spreading device (4, 4A, 4B, 4C) according to claim 1, characterized in that the respective individual spreading element (11) has at least two deformation areas (75, 76) with opposing and at least partially mutually canceling deformation effects, in particular with regard to the contact surface (13).

15. A spreading device (4, 4A, 4B, 4C) according to claim 8, characterized in that the connecting area (19) has a higher weight than the contact surface area (16).

16. A spreading device (4, 4A, 4B, 4C) according to claim 8, characterized in that the connecting area (19) has a greater thickness than the contact surface area (16).

17. A spreading device (4, 4A, 4B, 4C) according to claim 8, characterized in that the connecting area (19) has a greater curvature than the contact surface area (16).

18. A spreading device (4, 4A, 4B, 4C) according to claim 8, characterized in that the connecting area (19) has a single center of gravity (18) which is arranged closer to a vertical plane (15A) spanned by a tilting axis (15) than a single center of gravity (17) of the contact surface area (16).

19. An expander roller (1; 40) for laterally spreading a flat material web (33) in axial spreading directions (5, 7, 8) with a peripheral surface (9A) by means of which the expander roller (1) can be brought into operative contact with the flat material web (33), with a rotation axis (60) around which the expander roller (1) can rotate, and with spreading devices (4, 4A, 4B, 40) comprising a plurality of individual spreading elements (11) which form the peripheral surface (9A), characterized In that the expander roller (1) comprises a spreading device which comprises an elastically deformable support part (12) for arranging on a rotational body (3) and with a number of elastically deformable individual spreading elements (11; 30, 31) to achieve a spreading effect directed in the main spreading direction (5, 7, 8), in which the respective individual spreading element (11; 30, 31) has a contact surface area (16) at its free end (11A) facing away from the carrier part (12) with a contact surface (13) to interact with the flat material web (33) on the one hand and is arranged on the carrier part (12) at its second end (11B) facing away from the free end (11A) on the other hand, characterized In that the spreading device (4, 4A, 4B, 4C) is designed such that the respective individual spreading element (11; 30, 31) can be tilted at least partially or entirely in the direction of the free end by means of centrifugal force (27).

20. An expander roller (1; 40) for laterally spreading a flat material web (33) in axial spreading directions (5, 7, 8), having an enveloping circumferential surface (9A) by means of which the expander roller (1; 40) is brought into operative contact with a flat material web (33), having a rotation axis (60) around which the expander roller (1; 40) is rotatable, and having a plurality of spreading element rings (4C) which form the circumferential surface (9A) and which are mounted from the center (42; 51) to the roller edge (1B) in the spreading direction (5, 7, 8), and the spreading element rings (4C) are equipped with individual spreading elements (11) such that each individual spreading element (11) can move freely with and without load, and without contact with the neighboring elements (11), according to claim 19, characterized in that the position of individual centers of gravity (17, 18) of each individual spreading element (11) is designed in such a way that the effect of centrifugal forces (20, 27) at high speeds at least partially does not affect an increase in diameter (53) of the expander roller (1; 40) and the contact surfaces (13) remain parallel or at a small angle to the flat material web (33) under the action of centrifugal force and carry out the spreading under all operating conditions, and the individual spreading elements (11) remain free and without contact with any limiting means in their functional position even without contact with the material web.

21. An expander roller (1; 40) for laterally spreading a flat material web (33) in axial spreading directions (5, 7, 8), having an enveloping circumferential surface (9A) by means of which the expander roller (1) is brought into operative contact with a flat material web (33), having a rotational axis (60) around which the expander roller (1; 40) is rotatable, and having a plurality of spreading element rings (4C) which form the circumferential surface (9A) and are mounted from the center (42; 51) to the roller edge (1B) in the spreading direction (5, 7, 8), and the spreading element rings (4C) are equipped with individual spreading elements (11) such that each individual spreading element (11) can move freely with and without load and without contact with the neighboring elements (11), according to claim 19, characterized in that the position of the individual center of gravity (18) of a connecting area (19) and the position of the individual center of gravity (17) of a contact surface area (16) relative to the pivot point (16) are designed such that the effect of the centrifugal forces (20, 27) are at least partially canceled out and thus no or only a slight increase in diameter (53) of the expander roller (1; 40) occurs.

22. A spreading device (4, 4A, 4B, 4C) or expander roller (1; 40) according to claim 1, characterized in that the mass volume of the connecting area (19) is greater than the mass volume of the contact surface area (16) and both parts (16, 19) are arranged on different sides (15B, 15C) with respect to the pivot point (26), thereby at least partially canceling out the effect of the centrifugal forces (20, 27).

23. A spreading device (4, 4A, 4B, 4C) or expander roller (1; 40) according to claim 22, characterized in that the individual spreading elements (11) are mounted in a single row on the support part (12) and are thus designed to form a ring of spreading elements (4C).

24. A spreading device (4, 4A, 4B, 4C) or expander roller (1; 40) according to claim 22, characterized in that the individual spreading elements (30, 31) are mounted in a double row on the support part (12) and are thus designed to form a ring of spreading elements (36).

25. A spreading device (4, 4A, 4B, 4C) or expander roller (1; 40) according to claim 22, characterized in that each individual spreading element (11; 30, 31) is C-shaped and the shape of the C is designed such that the connecting area (19) and the contact surface area (16) are shaped as a rounded arc without a recognizable step and the connecting area (19) is tapered in the direction of the support part (12).

26. Method for spreading a flat material web (33) with spreading devices (4, 4A, 4B, 4C) in particular an expander roller (1; 40), In which a plurality of elastically deformable individual spreading elements of the spreading device (4, 4A, 4B, 4C) are brought into operative contact with the flat material web, and in which the spreading device (4, 4A, 4B, 4C) rotates around a rotation axis during spreading of the flat material web, and in which the contact surface of the respective individual spreading element is deflected radially outward by centrifugal forces, characterized in that a radial deflection of the contact surface in a radially outward direction is reduced by centrifugal forces acting on the respective individual spreading element, while the individual spreading element is tilted by the centrifugal forces.

27. Use of an individual spreading element (11) according to claim 19 on an expander roller (1; 40) for reducing a radially outward deflection of a contact surface (13) arranged on the individual spreading element (11) as a function of centrifugal forces acting on the individual spreading element (11).
